(19) United States
(12) Patent Application Publication
(10) Pub. No.: US 2015/0303513 A1
(43) Pub. Date: Oct. 22, 2015

(54) NONAQUEOUS ELECTROLYTIC STORAGE ELEMENT

(71) Applicants: Anna HIROWATARI, (US); Eiko HIBINO, (US); Nobuaki ONAGI, (US); Okitoshi KIMURA, (US); Hisamitsu KAMEZAKI, (US); Yasunori SUGIMOTO, (US)

(72) Inventors: Anna HIROWATARI, Kanagawa (JP); Eiko HIBINO, Kanagawa (JP); Nobuaki ONAGI, Kanagawa (JP); Okitoshi KIMURA, Kanagawa (JP); Hisamitsu KAMEZAKI, Kanagawa (JP); Yasunori SUGIMOTO, Kanagawa (JP)

(21) Appl. No.: 14/649,434

(22) PCT Filed: Dec. 25, 2013
(86) PCT No.: PCT/JP2013/085320

§ 371 Date: Jun. 3, 2015

(30) Foreign Application Priority Data
Dec. 28, 2012 (JP) 2012-287401

(51) Int. Cl. H01M 10/0525; H01M 4/587; H01M 10/0568

(52) U.S. Cl. CPC H01M 10/0525; H01M 10/0568; H01M 4/587; H01M 2004/021

(57) ABSTRACT

To provide nonaqueous electrolytic storage element, containing: a positive electrode, which contains a positive electrode active material capable of accumulating and releasing anions; a negative electrode containing a negative electrode active material capable of accumulating and releasing cations; and a nonaqueous electrolyte containing an electrolyte salt, wherein a capacity of the negative electrode per unit area is larger than a capacity of the positive electrode per unit area, and wherein an amount of the electrolyte salt in the nonaqueous electrode at the time of completion of charging after 50 cycles of charging and discharging is 0.2 mol/L to 1 mol/L, where the cycle of charging and discharging contains charging the nonaqueous electrolytic storage element to 5.2 V with constant electric current of 0.5 mA/cm², followed by discharging the nonaqueous electrolytic storage element to 2.5 V with constant electric current of 0.5 mA/cm².

### TECHNICAL FIELD

The present invention relates to a nonaqueous electrolytic storage element.

### BACKGROUND ART

In recent years, accompanied by downsizing and enhanced performance of mobile devices, a nonaqueous electrolytic storage element has improved properties as a nonaqueous electrolyte storage element having high energy density and become widespread. Also, attempts are underway to improve gravimetric energy density of the nonaqueous electrolytic storage element, aiming to expand its application to electric vehicles.

Conventionally, a lithium ion nonaqueous electrolytic storage element including a positive electrode of a lithium-cobalt composite oxide, a negative electrode of carbon, and a nonaqueous electrolyte obtained by dissolving lithium salt in a nonaqueous solvent has been widely used as the nonaqueous electrolytic storage element.

Meanwhile, there is a nonaqueous electrolytic storage element, which is charged and discharged by intercalation or deintercalation of anions in a nonaqueous electrolyte to a positive electrode of a material, such as an electroconductive polymer, and a carbonaceous material, and by intercalation or deintercalation of lithium ions in the nonaqueous electrolyte to a negative electrode of a carbonaceous material (this type of battery may be referred to as “dual carbon battery cell” hereinafter) (see PTL 1).

In the dual carbon battery cell, as indicated by the following reaction formula, the cell is charged by intercalation of anions such as PF₆⁻ from the nonaqueous electrolyte to the positive electrode and by intercalation of Li⁺ from the nonaqueous electrolyte to the negative electrode, and the cell is discharged by deintercalation of anions such as PF₆⁻ and so on from the positive electrode and deintercalation of Li⁺ from the negative electrode to the nonaqueous electrolyte.
Positive electrode: PF₆⁻+nC [symbol] Cₙ(PF₆)+e⁻
Negative electrode: Li⁺+nC+e⁻ [symbol] LiCₙ
   → charging reaction
   [symbol] discharge reaction

A discharge capacity of the dual carbon battery cell is determined by an anion storage capacity of the positive electrode, an amount of possible anion release of the positive electrode, a cation storage amount of the negative electrode, an amount of possible cation release of the negative electrode, and an amount of anions and amount of cations in the nonaqueous electrolyte. Accordingly, in order to improve the discharge capacity of the dual carbon battery cell, it is necessary to increase not only a positive electrode active material and a negative electrode active material, but also an amount of the nonaqueous electrolyte containing lithium salt (see NPTL 1).

A quantity of electricity the dual carbon battery cell has is proportional to a total amount of anions and cations in the nonaqueous electrolyte. Accordingly, the energy the battery cell can be stored therein is proportional to a total mass of the nonaqueous electrolyte as well as the positive electrode active material and the negative electrode active material.

In the manner as described above, a nonaqueous electrolytic storage element, in which charging is performed by accumulating anions from a nonaqueous electrolyte to a positive electrode, and accumulating cations from the nonaqueous electrolyte to a negative electrode, and discharging is performed by releasing anions from the positive electrode and cations from the negative electrode, requires a sufficient amount of an electrolyte salt.

Since the amount of the electrolyte salt in the nonaqueous electrolyte reduces as charging is performed, charge polarization becomes large hence an expected quantity of electricity cannot be attained, and ion conductivity becomes low as the amount of the electrolyte salt in the nonaqueous electrolyte is low, which increases internal resistance.

Accordingly, there is a demand for a nonaqueous electrolytic storage element, which can prevent polarization of the storage element even at the end of charging, can be sufficiently charged, can improve ion conductivity, and can achieve improvement of an electrical capacity and low internal resistance.

### CITATION LIST

### Patent Literature

PTL 1: Japanese Patent Application Laid-Open (JP-A) No. 2005-251472

### Non-Patent Literature

NPL 1: Journal of The Electrochemical Society, 147(3) 899-901 (2000)

### SUMMARY OF INVENTION

### Technical Problem

The present invention aims to provide a nonaqueous electrolytic storage element, which can prevent polarization of the storage element even at the end of charging, can be sufficiently charged, can improve ion conductivity, and can achieve an improved capacity of electricity, and low internal resistance.

### Solution to Problem

As for the means for solving the aforementioned problems, the nonaqueous electrolytic storage element of the present invention, contains:
a positive electrode, which contains a positive electrode active material capable of accumulating and releasing anions;
a negative electrode containing a negative electrode active material capable of accumulating and releasing cations; and
a nonaqueous electrolyte containing an electrolyte salt,
wherein a capacity of the negative electrode per unit area is larger than a capacity of the positive electrode per unit area, and
wherein an amount of the electrolyte salt in the nonaqueous electrode at the time of completion of charging after 50 cycles of charging and discharging is 0.2 mol/L to 1 mol/L, where the cycle of charging and discharging contains charging the nonaqueous electrolytic storage element to 5.2 V with constant electric current of 0.5 mA/cm², followed by discharging the nonaqueous electrolytic storage element to 2.5 V with constant electric current of 0.5 mA/cm².

### Advantageous Effects of Invention

The present invention can solve the aforementioned various problems in the art and can provide a nonaqueous electrolytic storage element, which can prevent polarization of the storage element even at the end of charging, can be sufficiently charged, can improve ion conductivity, and can achieve an improved capacity of electricity, and low internal resistance.

### BRIEF DESCRIPTION OF DRAWINGS

FIG. 1 is a schematic diagram illustrating one example of the nonaqueous electrolytic storage element of the present invention.

### DESCRIPTION OF EMBODIMENTS

### Nonaqueous Electrolytic Storage Element

The nonaqueous electrolytic storage element of the present invention contains a positive electrode, a negative electrode, a nonaqueous electrolyte, and a separator, and may further contain other members according to the necessity.

The nonaqueous electrolytic storage element is appropriately selected depending on the intended purpose without any limitation, and examples thereof include a nonaqueous electrolyte secondary battery, and a nonaqueous electrolyte capacitor.

In the present invention, an amount of the electrolyte salt in the nonaqueous electrolyte at the time of completion of charging is 0.2 mol/L to 1 mol/L, preferably 0.4 mol/L to 1 mol/L, and more preferably 0.6 mol/L to 1 mol/L in view of resistance of the nonaqueous electrolyte and a capacity.

The amount of the electrolyte salt being X mol/L means a state where X mol of the electrolyte salt is dissolved in 1 L of a solvent at 25° C.

At the time of the completion of charging means the time after a final cycle is completed when a charging-discharging cycle is repetitively performed on the nonaqueous electrolytic storage element. Specifically, it is after the charging-discharging cycle is performed 50 times, where the charging-discharging cycle includes charging the nonaqueous electrolytic storage element to 5.2 V with constant electric current of 0.5 mA/cm², followed by discharging to 2.5 V with constant electric current of 0.5 mA/cm². Note that, the charging-discharging cycle can be performed by means of a commercially available charge/discharge device.

When the amount of the electrolyte salt is less than 0.2 mol/L, reduction in ion conductivity of the nonaqueous electrolyte becomes significant, which may make charging difficult. When the amount thereof is greater than 1 mol/L, an initial amount of the electrolyte salt becomes large, and therefore resistance may increase due to the increased viscosity, and production time and cost may increase as the penetration of the nonaqueous electrolyte into the separator or electrode becomes poor.

An amount of the electrolyte salt in the nonaqueous electrolytic storage element is appropriately selected depending on a positive material and negative material for use without any limitation. In the case where the positive electrode controls a capacity of the nonaqueous electrolytic storage element, an appropriate amount of the electrolyte salt is set based on the electric capacity of the positive electrode. In the case where the negative electrode controls a capacity of the nonaqueous electrolytic storage element, an appropriate amount of the electrolyte salt is set based on the electric capacity of the negative electrode.

This means that use of a nonaqueous solvent, in which an amount of the electrolyte salt that is equal to or greater than the amount thereof corresponding to an ampere-hour capacity generated when the charging operation (or discharging operation) of the positive electrode or negative electrode is performed, is preferable. In the case where a small amount of the electrolyte salt is used, the amount of the electrolyte salt significantly reduces as charging is performed, which leads to reduction in ion conductivity. Therefore, there is a problem that a sufficient charging capacity cannot be attained. As charging cannot be performed, moreover, a discharging capacity naturally becomes small.

The electric charge for charging and the amount of the electrolyte salt satisfy the following relational expression with the charging voltage of 4.3 V to 6 V.

3≦{the amount of the electrolyte salt (mol)/[the electric charge for charging (=an amount in Coulomb)/F]}≦12

Note that, in the relational expression above, F represents the Faraday constant.

By satisfying the relational expression, polarization of the nonaqueous electrolytic storage element can be prevented even at the end of charging, sufficient charging can be performed, ion conductivity can be increased, and an improved capacity of electricity and low internal resistance can be achieved.

Considering the relationship between a capacity of the positive electrode and a capacity of the negative electrode, it is important to inhibit reduction of the capacity due to the deterioration of the negative electrode in order to maintain stability of repetitive charging and discharging, and the capacity of the negative electrode per unit area, which is larger than the capacity of the positive electrode per unit area, is effective for inhibiting reduction of the discharge capacity caused by repetitively performed charging-discharging cycles.

The capacity rate (a capacity of the negative electrode/a capacity of the positive electrode) is appropriately selected depending on the intended purpose without any limitation, provided that the capacity of the negative electrode is larger than the capacity of the positive electrode, but it is preferably 2 times to 6 times, more preferably 3 times to 5 times. When the capacity ratio (the capacity of the negative electrode/the capacity of the positive electrode) is less than 2 times, a space for retaining the nonaqueous electrolyte becomes slightly insufficient. In order to compensate the insufficient space, it is important to increase a concentration of the electrolyte salt to improve the capacity. When the concentration of the electrolyte salt is high, however, resistance increases, properties thereof at low temperature degrades, and decomposition of the electrolyte salt at the positive electrode is accelerated. Accordingly, such capacity ratio is not preferable. When the capacity ratio (the capacity of the negative electrode/the capacity of the positive electrode) is more than 6 times, on the other hand, an improvement in the capacity and maintenance of cycle properties are achieved due to the retained amount of the nonaqueous electrolyte, but the energy density of the storage element itself may be lowered.

The capacity of the positive electrode per unit area and the capacity of the negative electrode per unit area mean a capacity of a positive electrode or negative electrode per se. In case of the positive electrode, for example, the capacity thereof per unit area is a capacity thereof for charging and discharging to the predetermined voltage when lithium is used as a counter electrode. The predetermined voltage is determined based on a charging method used when the nonaqueous electrolytic storage element of the present invention is constituted. In case of the negative electrode, a capacity of the negative electrode per unit area means a quantity of discharged electricity when cation accumulation is performed to 0 V, and releasing of cations is performed to 2V with a lithium electrode.

Moreover, cations are preferably accumulated in the negative electrode active material of the negative electrode in advance, as charging-discharging cycle properties can be improved further. Namely, it is preferred that, after forming the negative electrode material layer on a surface of the negative electrode collector, a predetermined amount of cation be accumulated in the negative electrode active material of the negative electrode.

The accumulated amount is appropriately selected depending on the intended purpose without any limitation, but it is preferred that at least an electrical capacity corresponding to a capacity of the positive electrode be accumulated, and it is more preferred that cations corresponding to 0.1 V be accumulated with respect to a lithium electrode described later.

A method for accumulating cations (e.g., lithium ions) in the negative electrode active material in advance is appropriately selected depending on the intended purpose without any limitation, and examples thereof include a mechanical charging method, an electrochemical charging method, and a chemical charging method.

In accordance with the mechanical charging method, charging is performed, for example, by mechanically bringing the negative electrode active material in contact with a material having lower electric potential than the negative electrode active material (such as metal lithium). More specifically, after bonding a predetermined amount of metal lithium to a surface of the negative electrode, or directing forming a film of metal lithium on a surface of the negative electrode through a vacuum process, such as vapor deposition, or transferring lithium metal, which is formed on a mold-releasing processed plastic substrate, onto a surface of the negative electrode, charging can be performed. In the mechanical charging method, moreover, after bringing a material having lower electric potential than the negative electrode active material into contact with a surface of the negative electrode, a progress of a charging reaction is accelerated by heating the negative electrode so that the duration required for the charging reaction can be shortened.

In accordance with the electrochemical charging method, the negative electrode is charged, for example, by immersing the negative electrode and the counter electrode in the electrolyte, and applying electric current between the negative electrode and the counter electrode. As for the counter electrode, for example, metal lithium can be used. As for the electrolyte, for example, a nonaqueous solvent, in which a lithium salt is dissolved, can be used.

In accordance with the electrochemical charging method, charging is preferably performed until charging termination voltage of the negative electrode becomes 0.05 V to 1.0 V with respect to metal lithium.

When the charging termination voltage of the negative electrode is lower than 0.05 V, metal lithium may be precipitated on a surface of the negative electrode. When the charging termination voltage thereof is higher than 1.0 V, an effect obtainable by predoping the negative electrode to increase a capacity may not be sufficiently exhibited.

A positive electrode, a negative electrode, a nonaqueous electrolyte, and a separator of the nonaqueous electrolytic storage element are sequentially explained hereinafter.

### <Positive Electrode>

The positive electrode is appropriately selected depending on the intended purpose without any limitation, provided that the positive electrode contains a positive electrode active material. Examples of the positive electrode include a positive electrode, which contains a positive electrode material layer containing a positive electrode active material, provided on a positive electrode collector.

A shape of the positive electrode is appropriately selected depending on the intended purpose without any limitation, and examples thereof include a plate shape.

### <<Positive Electrode Material Layer>>

The positive electrode material layer is appropriately selected depending on the intended purpose without any limitation. For example, the positive electrode material layer contains at least a positive electrode active material, and may further contain an electroconductive agent, a binder, a thickener, etc. according to necessity.

### Positive Electrode Active Material

The positive electrode active material is appropriately selected depending on the intended purpose without any limitation, provided that it is a material capable of reversibly accumulating and releasing anions. Examples thereof include a carbonaceous material, and an electroconductive polymer. Among them, a carbonaceous material is particularly preferable because of its high energy density.

Examples of the electroconductive polymer include polyaniline, polypyrrole, and polyparaphenylene.

Examples of the carbonaceous material include: black-lead (graphite), such as coke, artificial graphite, natural graphite; and a thermal decomposition product of an organic material under various thermal decomposition conditions. Among them, artificial graphite, and natural graphite are particularly preferable.

The carbonaceous material is preferably a carbonaceous material having high crystallinity. The crystallinity can be evaluated by X-ray diffraction, or Raman analysis. For example, in a powder X-ray diffraction pattern thereof using CuKa rays, the intensity ratio I_{2θ=22.3°}/I_{2θ=26.4°} of the diffraction peak intensity I_{2θ=22.3°} at 2θ=22.3° to the diffraction peak intensity I_{2θ=26.4°} at 2θ=26.4° is preferably 0.4 or less.

A BET specific surface area of the carbonaceous material as measured by nitrogen adsorption is preferably 1 m²/g to 100 m²/g. The average particle diameter (median diameter) of the carbonaceous material as measured by a laser diffraction-scattering method is preferably 0.1 μm to 100 μm.

### Binder

The binder is appropriately selected depending on the intended purpose without any limitation, provided that the binder is a material stable to a solvent or electrolytic solution used during the production of an electrode. Examples of the binder include: a fluorine-based binder, such as polyvinylidene fluoride (PVDF), and polytetrafluoroethylene (PTFE); styrene-butadiene rubber (SBR); and isoprene rubber. These may be used alone, or in combination.

### Thickener

Examples of the thickener include carboxy methyl cellulose (CMC), methyl cellulose, hydroxymethyl cellulose, ethyl cellulose, polyvinyl alcohol, oxidized starch, starch phosphate, and casein. These may be used alone, or in combination.

### Electroconductive Agent

Examples of the electroconductive agent include: a metal material, such as copper, and aluminum; and a carbonaceous material, such as carbon black, and acetylene black. These may be used alone, or in combination.

The average thickness of the positive electrode material layer is appropriately selected depending on the intended purpose without any limitation, but it is preferably 35 μm to 280 μm, more preferably 70 μm to 210 μm. When the average thickness thereof is less than 35 μm, an energy density of a resulting element may be reduced. When the average thickness thereof is greater than 280 μm, electric current characteristics may be degraded.

### <<Positive Electrode Collector>>

A material, shape, size, and structure of the positive electrode collector are appropriately selected depending on the intended purpose without any limitation.

The material of the positive electrode collector is appropriately selected depending on the intended purpose without any limitation, provided that it is composed of an electroconductive material. Examples thereof include stainless steel, nickel, aluminum, copper, titanium, and tantalum. Among them, stainless steel and aluminum are particularly preferable.

The shape of the positive electrode collector is appropriately selected depending on the intended purpose without any limitation.

The size of the positive electrode collector is appropriately selected depending on the intended purpose without any limitation, provided that it is a size appropriately used as an nonaqueous electrolytic storage element.

### Preparation Method of Positive Electrode

The positive electrode can be produced by applying a positive electrode material, which has been formed into slurry by appropriately adding the binder, the thickener, and the electroconductive agent, and a solvent to the positive electrode active material, onto the positive electrode collector, followed by drying. The solvent is appropriately selected depending on the intended purpose without any limitation, and examples thereof include an aqueous solvent, and an organic solvent. Examples of the aqueous solvent include water and alcohol. Examples of the organic solvent include N-methyl-2-pyrrolidone (NMP), and toluene.

Note that, the positive electrode active material may be subjected to roll molding as it is to form a sheet electrode, or to compression molding to form a pellet electrode.

### <Negative Electrode>

The negative electrode is appropriately selected depending on the intended purpose without any limitation, provided that the negative electrode contains a negative electrode active material. Examples of the negative electrode include a negative electrode, which contains a negative electrode material layer containing a negative electrode active material, provided on a negative electrode collector.

A shape of the negative electrode is appropriately selected depending on the intended purpose without any limitation, and examples thereof include a plate shape.

### <<Negative Electrode Material Layer>>

The negative electrode material layer contains at least a negative electrode active material, and may further contain a binder, an electroconductive agent, etc. according to necessity.

### Negative Electrode Active Material

The negative electrode active material is appropriately selected depending on the intended purpose without any limitation, provided that it is a material capable of reversibly accumulating and releasing cations. Examples of the negative electrode active material include: alkali metal ion; alkali earth metal; metal oxide capable of adsorbing and releasing alkali metal ion or alkali earth metal; metal capable of forming an alloy with alkali metal ion or alkali earth metal; an alloy containing the metal; a composite alloy compound containing the metal; and a non-reactive electrode due to physical adsorption of ions, such as a carbonaceous material having a large specific surface area. Among them, preferred is a material capable of reversibly accumulating and releasing lithium, or lithium ions, or both thereof, in view of the energy density, and more preferred is a non-reactive electrode in view of recycling capability.

Specific examples of the negative electrode active material include: a carbonaceous material; metal oxide capable of adsorbing and releasing lithium, such as antimony-doped tin oxide, and silicon monoxide; metal or alloy capable of forming an alloy with lithium, such as aluminum, tin, silicon, and zinc; a composite alloy compound composed of metal capable of forming an alloy with lithium, an alloy containing the metal, and lithium; and lithium metal nitride, such as lithium cobalt nitride. These may be used alone, or in combination. Among them, the carbonaceous material is particularly preferable in view of safety and cost.

Examples of the carbonaceous material include: black-lead (graphite), such as coke, artificial graphite, and natural graphite; and a thermal decomposition product of an organic material under various thermal decomposition conditions. Among them, artificial graphite, and natural graphite are particularly preferable.

### Binder

The binder is appropriately selected depending on the intended purpose without any limitation, and examples thereof include: a fluorine-based binder, such as polyvinylidene fluoride (PVDF), and polytetrafluoroethylene (PTFE); ethylene-propylene-butadiene rubber (EPBR); styrene-butadiene rubber (SBR); isoprene rubber; and carboxymethyl cellulose (CMC). These may be used alone, or in combination. Among them, the fluorine-based binder, such as polyvinylidene fluoride (PVDF) and polytetrafluoroethylene (PTFE), and carboxymethyl cellulose (CMC) are preferable, and CMC is particularly preferable, as CMC contributes to improvement in the number of repeated charging-discharging compared to other binders.

### Electroconductive Agent

Examples of the electroconductive agent include: a metal material, such as copper, and aluminum; and a carbonaceous material, such as carbon black, and acetylene black. These may be used alone, or in combination.

The average thickness of the negative electrode material layer is appropriately selected depending on the intended purpose without any limitation, but the average thickness thereof is preferably 35 μm to 280 μm, more preferably 70 μm to 210 μm. When the average thickness of the negative electrode material layer is less than 35 μm, an energy density may be reduced. When the average thickness thereof is greater than 280 μm, electrical properties may be degraded.

### <<Negative Electrode Collector>>

A material, shape, size and structure of the negative electrode collector are appropriately selected depending on the intended purpose without any limitation.

The material of the negative electrode collector is appropriately selected depending on the intended purpose without any limitation, provided that the material thereof is composed of an electroconductive material. Examples thereof include stainless steel, nickel, aluminum, and copper. Among them, stainless steel, and copper are particularly preferable.

The shape of the negative electrode collector is appropriately selected depending on the intended purpose without any limitation.

The size of the negative electrode collector is appropriately selected depending on the intended purpose without any limitation, provided that it can be a size usable for the nonaqueous electrolytic storage element.

### Preparation Method of Negative Electrode

The negative electrode can be produced by applying a negative electrode material, which has been formed into slurry by appropriately adding the binder, the electroconductive agent, and a solvent to the negative electrode active material, onto the negative electrode collector, followed by drying. As for the solvent, the aforementioned solvents usable in the preparation method of the positive electrode can be used.

Moreover, a composition, in which the binder, the electroconductive agent, etc. are added to the negative electrode active material, may be subjected to roll molding as it is to form a sheet electrode or to compression molding to form a pellet electrode. Alternatively, a thin layer of the negative electrode active material may be formed on the negative electrode collector by a method, such as vapor deposition, sputtering, and plating.

### <Nonaqueous Electrolyte>

The nonaqueous electrolyte is an electrolytic solution containing a nonaqueous solvent, an electrolyte salt.

### <<Nonaqueous Solvent>>

The nonaqueous solvent is appropriately selected depending on the intended purpose without any limitation, but it is preferably an aprotic organic solvent.

As for the aprotic organic solvent, there is a carbonate-based organic solvent, such as chain carbonate, and cyclic carbonate, and it is preferably a solvent having a low viscosity. Among them, the chain carbonate is preferable, as it has high solubility of the electrolyte salt.

Examples of the chain carbonate include dimethyl carbonate (DMC), diethylcarbonate (DEC), methylethylcarbonate (EMC), and methylpropionate (MP). Among them, dimethyl carbonate (DMC) is preferable.

An amount of DMC is appropriately selected depending on the intended purpose without any limitation, but it is preferably 70% by mass or greater, more preferably 90% by mass or greater, relative to the nonaqueous solvent. When the amount of the DMC is less than 70% by mass and the rest of the solvent is a cyclic compound (e.g., cyclic carbonate, and cyclic ester) having a high dielectric constant, a viscosity of a nonaqueous electrolyte, which is prepared to have a high concentration, such as 3 mol/L or higher, becomes excessively high, as an amount of the cyclic compound having a high dielectric constant is large. As a result, the nonaqueous electrolyte may be penetrated into an electrode, or a problem in diffusion of ions may occur.

Examples of the cyclic carbonate include propylenecarbonate (PC), ethylenecarbonate (EC), butylene carbonate (BC), and vinylene carbonate (VC).

In the case where a mixed solvent prepared by combining ethylenecarbonate (EC) as the cyclic carbonate with dimethyl carbonate (DMC) as the chain carbonate is used, a mixing ratio of ethylenecarbonate (EC) to dimethyl carbonate (DMC) is appropriately selected depending on the intended purpose without any limitation. The mass ratio (EC:DMC) is preferably 3:10 to 1:99, more preferably 3:10 to 1:20.

Note that, as for the nonaqueous solvent, an ester-based organic solvent, such as cyclic ester, and chain ester, and an ether-based organic solvent, such as cyclic ether, and chain ether, can be optionally used.

Examples of the cyclic ester include γ-butyrolactone (γBL), 2-methyl-γ-butyrolactone, acetyl-γ-butyrolactone, and γ-valerolactone.

Examples of the chain ester include alkyl propionate, dialkyl malonate, alkyl acetate (e.g., methyl acetate (MA), and ethyl acetate), and alkyl formate (e.g., methyl formate (MF), and ethyl formate).

Examples of the cyclic ether include tetrahydrofuran, alkyl tetrahydrofuran, alkoxy tetrahydrofuran, dialkoxy tetrahydrofuran, 1,3-dioxolan, alkyl-1,3-dioxolan, and 1,4-dioxolan.

Examples of the chain ether include 1,2-dimethoxyethane (DME), diethyl ether, ethylene glycol dialkyl ether, diethylene glycol dialkyl ether, triethylene glycol dialkyl ether, and tetraethylene glycol dialkyl ether.

### <<Electrolyte Salt>>

The electrolyte salt is not particularly limited, provided that it contains a halogen atom, is dissolved in a nonaqueous solvent, and exhibits high ion conductivity. As for the electrolyte salt, a combination of the following cation and the following anion can be used.

Examples of the cation include alkali metal ion, alkali earth metal ion, tetraalkyl ammonium ion, and Spiro quaternary ammonium ion.

Examples of the anion include Cl⁻, Br⁻, I⁻, ClO₄⁻, BF₄⁻, PF₆⁻, SbF₆⁻, CF₃SO₃⁻, (CF₃SO₂)₂N⁻, and (C₂F₅SO₂)₂N⁻.

Among the electrolyte salts containing a halogen atom, a lithium salt is particularly preferable, as use thereof improves a battery capacity.

The lithium salt is appropriately selected depending on the intended purpose without any limitation, and examples thereof include lithium hexafluorophosphate (LiPF₆), lithium perchlorate (LiClO₄), lithium chloride (LiCl), lithium fluoroborate (LiBF₄), lithium hexafluoroarsenate (LiAsF₆), lithium trifluorosulfonate (LiCF₃SO₃), lithium bistrifluoromethylsulfonyl imide (LiN(C₂F₅SO₂)₂), and lithium bisperfluoroethylsulfonyl imide (LiN(CF₂F₅SO₂)₂). These may be used alone, or in combination. Among them, LiPF₆ is particularly preferable in view of the size of the storage capacity of anions in the carbon electrode.

An amount of the electrolyte salt preferably satisfies the following relational expression:

3≦{an amount of the electrolyte salt (mol)/[the electric charge for charging(=an amount in Coulomb)/F]}≦12

Note that, in the relational expression, F represents Faraday constant.

Specifically, the amount (concentration) of the electrolyte salt is appropriately selected depending on the intended purpose without any limitation, but it is preferred that an amount of the electrolyte be small for the purpose of improving the energy density. More preferably, the amount of the electrolyte salt is 0.5 mol/L to 6 mol/L in the nonaqueous solvent. Even more preferably, the amount thereof is 1 mol/L to 4 mol/L for achieving both a desirable capacity and output of the storage element.

### <Separator>

The separator is provided between a positive electrode and a negative electrode for the purpose of preventing a short circuit between the positive electrode and the negative electrode.

A material, shape, size, and structure of the separator are appropriately selected depending on the intended purpose without any limitation.

Examples of the material of the separator include: paper, such as kraft paper, vinylon blended paper, and synthetic pulp blended paper; polyolefin nonwoven fabric, such as cellophane, a polyethylene graft membrane, and polypropylene melt-flow nonwoven fabric; polyamide nonwoven fabric; and glass fiber nonwoven fabric.

Among them, a material having a porosity of 50% or greater is preferable in view of holding a nonaqueous electrolyte.

As for the shape of the separator, a nonwoven type thereof is more preferable than a thin film type thereof having micropores, in view of its high porosity.

The average thickness of the separator is appropriately selected depending on the intended purpose without any limitation, but the average thickness thereof is preferably 20 μm to 100 μm. When the average thickness of the separator is less than 20 μm, an amount of the electrolyte retained may be small. When the average thickness thereof is greater than 100 μm, an energy density of a resulting element may be reduced.

As for a more preferable embodiment of the separator, it is preferred that a micropore film having a thickness of 30 μm or less be provided at the side of the negative electrode in order to prevent the positive-negative short circuit caused by precipitations of alkali metal or alkali earth metal at the side of the negative electrode, and a nonwoven cloth having a thickness of 20 μm to 100 μm and a porosity of 50% or greater be provided at the side of the positive electrode.

Examples of the shape of the separator include a sheet shape.

The size of the separator is appropriately selected depending on the intended purpose without any limitation, provided that it is the size usable for a nonaqueous electrolytic storage element.

The structure of the separator may be a single layer structure, or a multilayer structure.

### <Other Members>

Other members are appropriately selected depending on the intended purpose without any limitation, and examples thereof include an outer tin, and an electrode lead wire.

### <Production Method of Nonaqueous Electrolytic Storage Element>

The nonaqueous electrolytic storage element of the present invention can be produced by assembling the positive electrode, the negative electrode, the nonaqueous electrolyte, and the optional separator into an appropriate shape. Moreover, other members, such as an outer tin, can be used according to the necessity. A method for assembling the nonaqueous electrolytic storage element is appropriately selected from generally employed methods without any limitation.

The nonaqueous electrolytic storage element of the present invention is appropriately selected depending on the intended purpose without any limitation, but the maximum voltage during the charging and discharging thereof is preferably 4.3 V to 6.0 V. When the maximum voltage during the charging and discharging is lower than 4.3 V, anions cannot be sufficiently accumulated, which may reduce the capacity of the element. When the maximum voltage is higher than 6.0 V, decomposition of the solvent or electrolyte salt tends to be caused, which accelerate deterioration of the element.

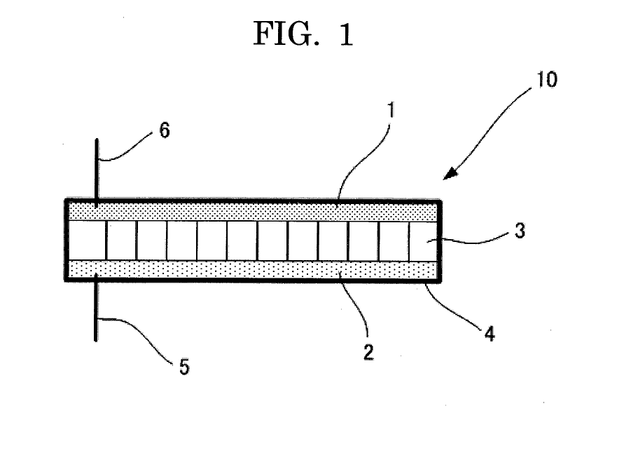

FIG. 1 is a schematic diagram illustrating one example of the nonaqueous electrolytic storage element of the present invention. The nonaqueous electrolytic storage element 10 contains, in an outer tin 4 thereof, a positive electrode 1 containing a positive electrode active material capable of reversibly accumulating and releasing anions, a negative electrode 2 containing a negative electrode active material capable of reversibly accumulating and releasing cations, and a separator 3 provided the positive electrode 1 and the negative electrode 2. These positive electrode 1, negative electrode 2, and separator 3 are immersed in a nonaqueous electrolyte (not illustrated) prepared by dissolving an electrolyte salt in a nonaqueous solvent. Note that, “5” denotes a negative electrode lead wire, and “6” denotes a positive electrode lead wire.

### Shape

A shape of the nonaqueous electrolytic storage element of the present invention is not particularly limited, and it may be appropriately selected from various shapes typically employed depending on use thereof. Examples thereof include a laminate electrode, a cylinder electrode where a sheet electrode and a separator are spirally provided, a cylinder element having an inside-out structure, in which a pellet electrode and a separator are used in combination, and a coin element, in which a pellet electrode and a separator are laminated.

### <Use>

Use of the nonaqueous electrolytic storage element of the present invention is not particularly limited, and it may be used for various applications. Examples thereof include a laptop computer, a stylus-operated computer, a mobile computer, an electronic book player, a mobile phone, a mobile fax, a mobile printer, a headphone stereo, a video movie, a liquid crystal television, a handy cleaner, a portable CD, a minidisk, a transceiver, an electronic organizer, a calculator, a memory card, a mobile tape recorder, a radio, a back-up power supply, a motor, a lighting equipment, a toy, a game equipment, a clock, a strobe, and a camera.

### EXAMPLES

Examples of the present invention are explained hereinafter, but Examples shall not be construed to limit the scope of the present invention.

### Production Example 1 of Positive Electrode

### Production of Positive Electrode I

As for a positive electrode active material, carbon powder (KS-6, manufactured by TIMCAL LTD.) was used. The carbon powder had a BET specific surface area of 20 m²/g as measured by nitrogen absorption, and had the average particle diameter (median diameter) of 3.4 μm, as measured by a laser diffraction particle size analyzer (SALD-2200, manufactured by Shimadzu Corporation).

To 2.7 g of the carbon powder (KS-6, manufactured by TIMCAL Ltd.) and 0.2 g of an electroconductive agent (acetylene black), water was added, and the resulting mixture was kneaded. To the resultant, 5 g of a 2% by mass carboxy methyl cellulose (CMC) aqueous solution was further added as a thickener, and the resulting mixture was kneaded to produce slurry. The obtained slurry was applied onto an aluminum foil, followed by vacuum drying for 4 hours at 120° C., to thereby produce a positive electrode. A circle having a diameter of 16 mm was stamped out of the positive electrode, to thereby prepare Positive Electrode I. A mass of the carbon powder (graphite) in Positive Electrode I applied on the aluminum (Al) foil having the diameter of 16 mm was 10 mg.

### Production Example 2 of Positive Electrode

### Production of Positive Electrode II

Positive Electrode II was produced in the same manner as in Production Example 1 of Positive Electrode, provided that the mass of the carbon powder (graphite) applied on the aluminum (Al) foil having the diameter of 16 mm was changed to 35 mg.

### Production Example 3 of Positive Electrode

### Production of Positive Electrode III

Positive Electrode III was produced in the same manner as in Production Example 1 of Positive Electrode, provided that the mass of the carbon powder (graphite) applied on the aluminum (Al) foil having the diameter of 16 mm was changed to 45 mg.

### Production Example 1 of Negative Electrode

### Production of Negative Electrode I

As for a negative electrode active material, carbon powder (MAGD, manufactured by. Hitachi Chemical Co., Ltd.) was used. The carbon powder had a BET specific surface area by nitrogen adsorption of 4.5 m²/g, the average particle diameter (median diameter) of 20 μm as measured by a laser diffraction particle size analyzer (SALD-2200, manufactured by Shimadzu Corporation), and a tap density of 630 kg/m³.

To 3 g of the carbon powder (graphite) and 0.15 g of an electroconductive agent (acetylene black), water was added, and the resulting mixture was kneaded. To the resultant, 4 g of a 3% by mass carboxy methyl cellulose (CMC) aqueous solution was further added as a thickener, and the resulting mixture was kneaded to thereby produce slurry. The obtained slurry was applied onto a Cu foil, followed by vacuum drying for 4 hours at 120° C., to thereby produce a negative electrode. A circle having a diameter of 16 mm was stamped out of the negative electrode, to thereby prepare Negative Electrode I. A mass of the carbon powder (graphite) in Negative Electrode I applied on the Cu foil having the diameter of 16 mm was 10 mg.

### Production Example 2 of Negative Electrode

### Production of Negative Electrode II

Negative Electrode II was produced in the same manner as in Production Example 1 of Negative Electrode, provided that the mass of the carbon powder (graphite) in the negative electrode applied onto the Cu foil having the diameter of 16 mm was changed to 5 mg.

### Production Example 3 of Negative Electrode

### Production of Negative Electrode III

Negative Electrode III was produced in the same manner as in Production Example 1 of Negative Electrode, provided that the mass of the carbon powder (graphite) in the negative electrode applied onto the Cu foil having the diameter of 16 mm was changed to 15 mg.

### Production Example 4 of Negative Electrode

### Production of Negative Electrode IV

Negative Electrode IV was produced in the same manner as in Production Example 1 of Negative Electrode, provided that the mass of the carbon powder (graphite) in the negative electrode applied onto the Cu foil having the diameter of 16 mm was changed to 26 mg.

### <Preparation of Nonaqueous Electrolyte A>

As for Nonaqueous Electrolyte A, 0.35 mL of dimethyl carbonate (DMC), in which 0.05 mol/L of LiPF₆ had been dissolved at 25° C., was prepared.

### <Preparation of Nonaqueous Electrolyte B>

As for Nonaqueous Electrolyte B, 0.35 mL of dimethyl carbonate (DMC), in which 0.1 mol/L of LiPF₆ had been dissolved at 25° C., was prepared.

### <Preparation of Nonaqueous Electrolyte C>

As for Nonaqueous Electrolyte C, 0.35 mL of dimethyl carbonate (DMC), in which 0.3 mol/L of LiPF₆ had been dissolved at 25° C., was prepared.

### <Preparation of Nonaqueous Electrolyte D>

As for Nonaqueous Electrolyte D, 0.35 mL of dimethyl carbonate (DMC), in which 0.5 mol/L of LiPF₆ had been dissolved at 25° C., was prepared.

### <Preparation of Nonaqueous Electrolyte E>

As for Nonaqueous Electrolyte E, 0.35 mL of dimethyl carbonate (DMC), in which 0.7 mol/L of LiPF₆ had been dissolved at 25° C., was prepared.

### <Preparation of Nonaqueous Electrolyte F>

As for Nonaqueous Electrolyte F, 0.35 mL of dimethyl carbonate (DMC), in which 1.0 mol/L of LiPF₆ had been dissolved at 25° C., was prepared.

### <Preparation of Nonaqueous Electrolyte G>

As for Nonaqueous Electrolyte G, 0.1 mL of dimethyl carbonate (DMC), in which 2.0 mol/L of LiPF₆ had been dissolved at 25° C., was prepared.

### <Preparation of Nonaqueous Electrolyte H>

As for Nonaqueous Electrolyte H, 0.1 mL of dimethyl carbonate (DMC), in which 2.2 mol/L of LiPF₆ had been dissolved at 25° C., was prepared.

### <Separator 1 (PP)>

As for a separator, a polypropylene separator (manufactured by JMT INC.) having a thickness of 20 μm and a porosity of 60% was prepared.

### <Separator 2 (GF)>

As for a separator, GA-100 GLASS FIBER FILTER (thickness: 100 μm) manufactured by ADVANTEC Group was prepared.

### <Confirmation of Capacities of Positive Electrodes I to III>

Positive Electrode I, II, or III, a separator [a three-layer structure containing Separator 1(PP)/Separator 2(GF)/Separator 1(PP)], Nonaqueous Electrolyte F, and lithium (manufactured by Honjo Metal Co., Ltd., thickness: 200 μm) as a negative electrode were placed in a tin for producing a coin storage element (2032 type, manufactured by Hohsen Corp.), to thereby assemble each nonaqueous electrolytic storage element.

Each of the obtained nonaqueous electrolytic storage element was charged to the charge termination voltage of 5.2 V with constant electric current of 0.5 mA/cm² at room temperature (25° C.). After the first charging, the nonaqueous electrolytic storage element was discharged to 2.5 V with constant electric current of 0.5 mA/cm², to thereby perform initial charging and discharging. The storage element after the initial charging and discharging was charged to 5.2 V with constant electric current of 0.5 mA/cm², followed by discharging the storage element to 2.5 V with constant electric current of 0.5 mA/cm². The aforementioned charging and discharging process was determined as 1 cycle of charging and discharging. This charging-discharging cycle was performed twice, and a capacity of the positive electrode per unit area was measured. As a result, the capacity of Positive Electrode I was 0.42 mAh/cm², the capacity of Positive Electrode II was 1.49 mAh/cm², and the capacity of Positive Electrode III was 1.67 mAh/cm². Note that, the charging-discharging test was performed by means of a charge/discharge measurement device (TOSCAT3001, manufactured by TOYO SYSTEM CO., LTD.), and impedance was measured by means of 1286 and 1260 manufactured by Solartron Analytical.

### <Conformation of Capacities of Negative Electrode I to IV>

Negative Electrode, I, II, III, or IV, a separator [a three-layer structure containing Separator 1(PP)/Separator 2(GF)/Separator 1(PP)], Nonaqueous Electrolyte F, and lithium (manufactured by Honjo Metal Co., Ltd., thickness: 200 μm) as a counter electrode were placed in a tin for producing a coin storage element (2032 type, manufactured by Hohsen Corp.), to thereby assemble each nonaqueous electrolytic storage element.

Each of the obtained nonaqueous electrolytic storage element was charged to the charge termination voltage of 0 V with constant electric current of 0.5 mA/cm² at room temperature (25° C.). After the first charging, the nonaqueous electrolytic storage element was discharged to 2.5 V with constant electric current of 0.5 mA/cm², to thereby perform initial charging and discharging. The storage element after the initial charging and discharging was charged to 0 V with constant electric current of 0.5 mA/cm², followed by discharging the storage element to 2.5 V with constant electric current of 0.5 mA/cm². The aforementioned charging and discharging process was determined as 1 cycle of charging and discharging. This charging-discharging cycle was performed twice, and a capacity of the negative electrode per unit area was measured. As a result, the capacity of Negative Electrode I was 1.8 mAh/cm², the capacity of Negative Electrode II was 0.9 mAh/cm², the capacity of Negative Electrode III was 2.3 mAh/cm², and the capacity of Negative Electrode IV was 4.5 mAh/cm². Note that, the charging-discharging test was performed by means of a charge/discharge measurement device (TOSCAT3001, manufactured by TOYO SYSTEM CO., LTD.), and impedance was measured by means of 1286 and 1260 manufactured by Solartron Analytical.

### Example 1

Positive Electrode I, a separator [a three-layer structure containing Separator 1(PP)/Separator 2(GF)/Separator 1(PP)], Nonaqueous Electrolyte F, and lithium (manufactured by Honjo Metal Co., Ltd., thickness: 200 μm) as a negative electrode were placed in a tin for producing a coin storage element (2032 type, manufactured by Hohsen Corp.), to thereby produce a nonaqueous electrolytic storage element of Example 1.

The obtained nonaqueous electrolytic storage element was subjected to measurements of a charging capacity at 50th cycle, an amount of the electrolyte salt at the time of the completion of charging, and alternating-current resistance in the following manners. The results are presented in Table 2.

### <Charging Capacity at 50th Cycle>

The produced nonaqueous electrolytic storage element was charged to the charge termination voltage of 5.2 V with constant electric current of 0.5 mA/cm² at room temperature (25° C.). After the first charging, the nonaqueous electrolytic storage element was discharged to 2.5 V with constant electric current of 0.5 mA/cm², to thereby perform initial charging and discharging. The storage element after the initial charging and discharging was charged to 5.2 V with constant electric current of 0.5 mA/cm², followed by discharging the storage element to 2.5 V with constant electric current of 0.5 mA/cm². The aforementioned charging and discharging process was determined as 1 cycle of charging and discharging. This charging-discharging cycle was performed 50 cycles. The charging capacity at the 50th cycle was measured, and the result thereof was 83.4 mAh/g. Note that, the charging-discharging test was performed by means of a charge/discharge measurement device (TOSCAT3001, manufactured by TOYO SYSTEM CO., LTD.), and impedance was measured by means of 1286 and 1260 manufactured by Solartron Analytical.

### <Amount of Electrolyte Salt at the Time of Completion of Charging>

An amount (concentration) of the electrolyte salt at the time of the completion of charging was determined from the charging capacity at the 50th cycle, an amount of the electrolyte added, and an amount of the nonaqueous solvent added in the following manner.

A: Molar quantity of the electrolyte required for charging=the charging capacity (mAh/g)×a mass of the active material (g)×a conversion factor 3.6(C/mAh)/F(C/mol)

Note that, F represents Faraday constant.

B: Molar quantity of the electrolyte placed in the nonaqueous electrolytic storage element=a concentration of the electrolyte salt (mol/L)×an amount of the nonaqueous solvent (L) An amount of the electrolyte salt at the time of completion of charging=(B−A)/the amount of the nonaqueous solvent

The amount (concentration) of the electrolyte salt at the time of the completion of charging determined as described above was 0.912 mol/L.

### <Alternating-Current Resistance>

Next, the nonaqueous electrolytic storage element, on which 50 cycles of the charging-discharging test had been performed, was taken out from the charge/discharge measurement device, and then was subjected to a measurement of alternating-current resistance (real number resistance) at the AC amplitude of ±5 mVrms (100 kHz) by means of 1286 and 1260 manufactured by Solartron Analytical. The result thereof was 6.998 Ω.

### Example 2

A nonaqueous electrolytic storage element of Example 2 was produced in the same manner as in Example 1, provided that Nonaqueous Electrolyte F was replaced with Nonaqueous Electrolyte E.

The obtained nonaqueous electrolytic storage element was subjected to the measurements of the charging capacity at 50th cycle, an amount of the electrolyte at the time of completion of charging, and alternating-current resistance in the same manners as in Example 1. The results are presented in Table 2.

### Example 3

A nonaqueous electrolytic storage element of Example 3 was produced in the same manner as in Example 1, provided that Nonaqueous Electrolyte F was replaced with Nonaqueous Electrolyte D.

The obtained nonaqueous electrolytic storage element was subjected to the measurements of the charging capacity at 50th cycle, an amount of the electrolyte at the time of completion of charging, and alternating-current resistance in the same manners as in Example 1. The results are presented in Table 2.

### Example 4

A nonaqueous electrolytic storage element of Example 4 was produced in the same manner as in Example 1, provided that Nonaqueous Electrolyte F was replaced with Nonaqueous Electrolyte C.

The obtained nonaqueous electrolytic storage element was subjected to the measurements of the charging capacity at 50th cycle, an amount of the electrolyte at the time of completion of charging, and alternating-current resistance in the same manners as in Example 1. The results are presented in Table 2.

### Example 5

A nonaqueous electrolytic storage element of Example 5 was produced in the same manner as in Example 1, provided that Nonaqueous Electrolyte F was replaced with Nonaqueous Electrolyte H, and Positive Electrode I was replaced with Positive Electrode III.

The obtained nonaqueous electrolytic storage element was subjected to the measurements of the charging capacity at 50th cycle, an amount of the electrolyte at the time of completion of charging, and alternating-current resistance in the same manners as in Example 1. The results are presented in Table 2.

### Comparative Example 1

A nonaqueous electrolytic storage element of Comparative Example 1 was produced in the same manner as in Example 1, provided that Nonaqueous Electrolyte F was replaced with Nonaqueous Electrolyte B.

The obtained nonaqueous electrolytic storage element was subjected to the measurements of the charging capacity at 50th cycle, an amount of the electrolyte at the time of completion of charging, and alternating-current resistance in the same manners as in Example 1. The results are presented in Table 2.

Comparative Example 1 had the significantly high alternating-current resistance compared to Examples 1 to 5, and could not be charged. Accordingly, it was found that the amount of the electrolyte salt at the time of the completion of charging was desirably the result thereof of Example 4 (0.239 mol/L) or greater.

### Comparative Example 2

A nonaqueous electrolytic storage element of Comparative Example 2 was produced in the same manner as in Example 1, provided that Nonaqueous Electrolyte F was replaced with Nonaqueous Electrolyte A.

The obtained nonaqueous electrolytic storage element was subjected to the measurements of the charging capacity at 50th cycle, an amount of the electrolyte at the time of completion of charging, and alternating-current resistance in the same manners as in Example 1. The results are presented in Table 2.

Comparative Example 2 had the significantly high alternating-current resistance compared to Examples 1 to 5, and could not be charged. Accordingly, it was found that the amount of the electrolyte salt at the time of the completion of charging was desirably the result thereof of Example 4 (0.239 mol/L) or greater.

### Example 6

Positive Electrode I, a separator [a three-layer structure containing Separator 1(PP)/Separator 2(GF)/Separator 1(PP)], Negative Electrode I, and Nonaqueous Electrolyte F were placed in a tin for producing a coin storage element (2032 type, manufactured by Hohsen Corp.), to thereby produce a nonaqueous electrolytic storage element of Example 6.

The obtained nonaqueous electrolytic storage element was subjected to measurements of a charging capacity at 50th cycle, an amount of the electrolyte salt at the time of the completion of charging, and alternating-current resistance in the following manners. The results are presented in Table 2.

### <Charging Capacity at 50th Cycle>

The produced nonaqueous electrolytic storage element was charged to the charge termination voltage of 5.2 V with constant electric current of 0.5 mA/cm² at room temperature (25° C.). After the first charging, the nonaqueous electrolytic storage element was discharged to 2.5 V with constant electric current of 0.5 mA/cm², to thereby perform initial charging and discharging. The storage element after the initial charging and discharging was charged to 5.2 V with constant electric current of 0.5 mA/cm², followed by discharging the storage element to 2.5 V with constant electric current of 0.5 mA/cm². The aforementioned charging and discharging process was determined as 1 cycle of charging and discharging. This charging-discharging cycle was performed 50 cycles. The charging capacity at the 50th cycle was measured, and the result thereof was 85.79 mAh/g. Note that, the charging-discharging test was performed by means of a charge/discharge measurement device (TOSCAT3001, manufactured by TOYO SYSTEM CO., LTD.), and impedance was measured by means of 1286 and 1260 manufactured by Solartron Analytical.

### <Amount of Electrolyte Salt at the Time of Completion of Charging>

An amount (concentration) of the electrolyte salt at the time of the completion of charging was determined from the charging capacity at the 50th cycle, an amount of the electrolyte added, and an amount of the nonaqueous solvent added in the same manner as in Example 1. The result thereof was 0.909 mol/L.

### <Alternating-Current Resistance>

Next, the nonaqueous electrolytic storage element, on which 50 cycles of the charging-discharging test had been performed, was taken out from the charge/discharge measurement device, and then was subjected to a measurement of alternating-current resistance (real number resistance) at the AC amplitude of ±5 mVrms (100 kHz) in the same manner as in Example 1. The result thereof was 27.45 Ω.

### Example 7

A nonaqueous electrolytic storage element of Example 7 was produced in the same manner as in Example 6, provided that Nonaqueous Electrolyte F was replaced with Nonaqueous Electrolyte E.

The obtained nonaqueous electrolytic storage element was subjected to the measurements of the charging capacity at 50th cycle, an amount of the electrolyte at the time of completion of charging, and alternating-current resistance in the same manners as in Example 6. The results are presented in Table 2.

### Example 8

A nonaqueous electrolytic storage element of Example 8 was produced in the same manner as in Example 6, provided that Nonaqueous Electrolyte F was replaced with Nonaqueous Electrolyte D.

The obtained nonaqueous electrolytic storage element was subjected to the measurements of the charging capacity at 50th cycle, an amount of the electrolyte at the time of completion of charging, and alternating-current resistance in the same manners as in Example 6. The results are presented in Table 2.

### Example 9

A nonaqueous electrolytic storage element of Example 9 was produced in the same manner as in Example 6, provided that Nonaqueous Electrolyte F was replaced with Nonaqueous Electrolyte C.

The obtained nonaqueous electrolytic storage element was subjected to the measurements of the charging capacity at 50th cycle, an amount of the electrolyte at the time of completion of charging, and alternating-current resistance in the same manners as in Example 6. The results are presented in Table 2.

### Example 10

A nonaqueous electrolytic storage element of Example 10 was produced in the same manner as in Example 6, provided that Nonaqueous Electrolyte F was replaced with Nonaqueous Electrolyte G, Positive Electrode I was replaced with Positive Electrode II, and Negative Electrode I was replaced with Negative Electrode IV.

The obtained nonaqueous electrolytic storage element was subjected to the measurements of the charging capacity at 50th cycle, an amount of the electrolyte at the time of completion of charging, and alternating-current resistance in the same manners as in Example 6. The results are presented in Table 2.

### Example 11

A nonaqueous electrolytic storage element of Example 11 was produced in the same manner as in Example 6, provided that Negative Electrode I was replaced with Negative Electrode II.

The obtained nonaqueous electrolytic storage element was subjected to the measurements of the charging capacity at 50th cycle, an amount of the electrolyte at the time of completion of charging, and alternating-current resistance in the same manners as in Example 6. The results are presented in Table 2.

### Example 12

A nonaqueous electrolytic storage element of Example 12 was produced in the same manner as in Example 6, provided that Negative Electrode I was replaced with Negative Electrode III.

The obtained nonaqueous electrolytic storage element was subjected to the measurements of the charging capacity at 50th cycle, an amount of the electrolyte at the time of completion of charging, and alternating-current resistance in the same manners as in Example 6. The results are presented in Table 2.

### Comparative Example 3

A nonaqueous electrolytic storage element of Comparative Example 3 was produced in the same manner as in Example 6, provided that Nonaqueous Electrolyte F was replaced with Nonaqueous Electrolyte B.

The obtained nonaqueous electrolytic storage element was subjected to the measurements of the charging capacity at 50th cycle, an amount of the electrolyte at the time of completion of charging, and alternating-current resistance in the same manners as in Example 6. The results are presented in Table 2.

Comparative Example 3 had the significantly high alternating-current resistance compared to Examples 6 to 12, and could not be charged. Accordingly, it was found that the amount of the electrolyte salt at the time of the completion of charging was desirably the result thereof of Example 9 (0.271 mol/L) or greater.

### Comparative Example 4

A nonaqueous electrolytic storage element of Comparative Example 4 was produced in the same manner as in Example 6, provided that Nonaqueous Electrolyte F was replaced with Nonaqueous Electrolyte A.

The obtained nonaqueous electrolytic storage element was subjected to the measurements of the charging capacity at 50th cycle, an amount of the electrolyte at the time of completion of charging, and alternating-current resistance in the same manners as in Example 6. The results are presented in Table 2.

Comparative Example 4 had the significantly high alternating-current resistance compared to Examples 6 to 12, and could not be charged. Accordingly, it was found that the amount of the electrolyte salt at the time of the completion of charging was desirably the result thereof of Example 9 (0.271 mol/L) or greater.

Next, the results of Examples 1 to 12, and Comparative Examples 1 to 4, regarding the capacity of the positive electrode, the capacity of the negative electrode, and the capacity ratio (capacity of negative electrode/capacity of positive electrode) are collectively presented in Table 1 below.

TABLE 1

| | | | Capacity ratio |
|---|---|---|---|
| | Capacity of | Capacity of | (capacity of |
| | positive | negative | negative |
| | electrode | electrode | electrode/capacity of |
| | (mAh/cm²) | (mAh/cm²) | positive electrode) |
| Ex. 1 | 0.42 | 41 | 97.6 |
| Ex. 2 | 0.42 | 41 | 97.6 |
| Ex. 3 | 0.42 | 41 | 97.6 |
| Ex. 4 | 0.42 | 41 | 97.6 |
| Ex. 5 | 1.67 | 41 | 24.6 |
| Comp. | 0.42 | 41 | 97.6 |
| Ex. 1 | | | |
| Comp. | 0.42 | 41 | 97.6 |
| Ex. 2 | | | |
| Ex. 6 | 0.42 | 1.8 | 4.3 |
| Ex. 7 | 0.42 | 1.8 | 4.3 |
| Ex. 8 | 0.42 | 1.8 | 4.3 |
| Ex. 9 | 0.42 | 1.8 | 4.3 |
| Ex. 10 | 1.49 | 4.5 | 3.0 |
| Ex. 11 | 0.42 | 0.9 | 2.1 |
| Ex. 12 | 0.42 | 2.3 | 5.5 |
| Comp. | 0.42 | 1.8 | 4.3 |
| Ex. 3 | | | |
| Comp. | 0.42 | 1.8 | 4.3 |
| Ex. 4 | | | |

In Table 1, the capacity of Li serving as a negative electrode in each of Examples 1 to 5 and Comparative Examples 1 and 2 is a calculated value, which is calculated from a volume of Li used, using a concentration of Li, an atomic weight of Li, and the Faraday constant.

TABLE 2

| | Nonaqueous | | | | Amount of |
|---|---|---|---|---|---|
| | electrolyte | | | | electrolyte |
| | | Initial | | | salt at the |
| | | amount of | Charging | Alternating- | time of |
| | | nonaqueous | capacity at | current | completion of |
| | | electrolyte | 50th cycle | resistance | charging |
| | Type | (mol/L) | (mAh/g) | (Ω) | (mol/L) |
| Ex. 1 | F | 1.0 | 83.4 | 6.998 | 0.912 |
| Ex. 2 | E | 0.7 | 82.65 | 9.93 | 0.612 |
| Ex. 3 | D | 0.5 | 69.01 | 22.44 | 0.426 |
| Ex. 4 | C | 0.3 | 34.47 | 72.68 | 0.239 |
| Ex. 5 | H | 2.2 | 74.44 | 11.63 | 0.95 |
| Comp. | B | 0.1 | 0.0142 | 3,778.70 | 0.09998 |
| Ex. 1 | | | | | |
| Comp. | A | 0.05 | 0.00151 | 23,653 | 0.049998 |
| Ex. 2 | | | | | |
| Ex. 6 | F | 1.0 | 85.79 | 27.45 | 0.909 |
| Ex. 7 | E | 0.7 | 83.60 | 9.858 | 0.611 |
| Ex. 8 | D | 0.5 | 66.02 | 26.93 | 0.430 |
| Ex. 9 | C | 0.3 | 27.08 | 123.3 | 0.271 |
| Ex. 10 | G | 2.0 | 85.1 | 30.12 | 0.888 |
| Ex. 11 | F | 1.0 | 75.2 | 7.22 | 0.92 |
| Ex. 12 | F | 1.0 | 80.2 | 7.86 | 0.915 |
| Comp. | B | 0.1 | 0.0248 | 3,764.30 | 0.09997 |
| Ex. 3 | | | | | |
| Comp. | A | 0.05 | 0.00678 | 23,175 | 0.049993 |
| Ex. 4 | | | | | |

In Table 2, “A” to “G” depicted in the columns of the type of the nonaqueous electrolyte represent Nonaqueous Electrolyte A to Nonaqueous Electrolyte G, respectively.

The embodiments of the present invention are, for example, as follows:

<1> A nonaqueous electrolytic storage element, containing:

a positive electrode, which contains a positive electrode active material capable of accumulating and releasing anions;

a negative electrode containing a negative electrode active material capable of accumulating and releasing cations; and

a nonaqueous electrolyte containing an electrolyte salt,

wherein a capacity of the negative electrode per unit area is larger than a capacity of the positive electrode per unit area, and

wherein an amount of the electrolyte salt in the nonaqueous electrode at the time of completion of charging after 50 cycles of charging and discharging is 0.2 mol/L to 1 mol/L, where the cycle of charging and discharging contains charging the nonaqueous electrolytic storage element to 5.2 V with constant electric current of 0.5 mA/cm², followed by discharging the nonaqueous electrolytic storage element to 2.5 V with constant electric current of 0.5 mA/cm².

<2> The nonaqueous electrolytic storage element according to <1>, wherein the amount of the electrolyte salt in the nonaqueous electrode at the time of completion of charging is 0.6 mol/L to 1 mol/L.
<3> The nonaqueous electrolytic storage element according to any of <1> to <2>, wherein the capacity of the negative electrode per unit area is 2 times to 6 times the capacity of the positive electrode per unit area.
<4> The nonaqueous electrolytic storage element according to <3>, wherein the capacity of the negative electrode per unit area is 3 times to 5 times the capacity of the positive electrode per unit area.
<5> The nonaqueous electrolytic storage element according to any one of <1> to <4>, wherein the electrolyte salt is LiPF₆.
<6> The nonaqueous electrolytic storage element according to any one of <1> to <5>, wherein an amount of the electrolyte salt is 0.5 mol/L to 6 mol/L.
<7> The nonaqueous electrolytic storage element according to any one of <1> to <6>, wherein a maximum voltage of the nonaqueous electrolytic storage element during charging and discharging is 4.3 V to 6.0 V.
<8> The nonaqueous electrolytic storage element according to any one of <1> to <7>, wherein an electric charge for charging and the amount of the electrolyte salt satisfy the following relational expression at charging voltage of 4.3 V to 6 V:

3≦{the amount of the electrolyte salt (mol)/[the electric charge for charging (=an amount in Coulomb)/F]}≦12

where F is Faraday constant.

<9> The nonaqueous electrolytic storage element according to any one of <1> to <8>, wherein the positive electrode active material is a carbonaceous material.
<10> The nonaqueous electrolytic storage element according to any one of <1> to <9>, wherein the negative electrode active material is a carbonaceous material.

### REFERENCE SIGNS LIST

1 positive electrode
2 negative electrode
3 separator
4 outer tin
5 negative electrode lead wire
6 positive electrode lead wire
10 nonaqueous electrolytic storage element

1. A nonaqueous electrolytic storage element, comprising:
a positive electrode, which comprises a positive electrode active material capable of accumulating and releasing anions;
a negative electrode comprising a negative electrode active material capable of accumulating and releasing cations; and
a nonaqueous electrolyte comprising an electrolyte salt,
wherein a capacity of the negative electrode per unit area is larger than a capacity of the positive electrode per unit area, and
wherein an amount of the electrolyte salt in the nonaqueous electrode at the time of completion of charging after 50 cycles of charging and discharging is 0.2 mol/L to 1 mol/L, where the cycle of charging and discharging is carried out by charging the nonaqueous electrolytic storage element to 5.2 V with constant electric current of 0.5 mA/cm², followed by discharging the nonaqueous electrolytic storage element to 2.5 V with constant electric current of 0.5 mA/cm².

2. The nonaqueous electrolytic storage element according to claim 1, wherein the amount of the electrolyte salt in the nonaqueous electrode at the time of completion of charging is 0.6 mol/L to 1 mol/L.

3. The nonaqueous electrolytic storage element according to claim 1, wherein the capacity of the negative electrode per unit area is 2 times to 6 times the capacity of the positive electrode per unit area.

4. The nonaqueous electrolytic storage element according to claim 3, wherein the capacity of the negative electrode per unit area is 3 times to 5 times the capacity of the positive electrode per unit area.

5. The nonaqueous electrolytic storage element according to claim 1, wherein the electrolyte salt is LiPF₆.

6. The nonaqueous electrolytic storage element according to claim 1, wherein an amount of the electrolyte salt is 0.5 mol/L to 6 mol/L.

7. The nonaqueous electrolytic storage element according to claim 1, wherein a maximum voltage of the nonaqueous electrolytic storage element during charging and discharging is 4.3 V to 6.0 V.

8. The nonaqueous electrolytic storage element according to claim 1, wherein an electric charge for charging and the amount of the electrolyte salt satisfy the following relational expression at charging voltage of 4.3 V to 6 V:
3≦{the amount of the electrolyte salt (mol)/[the electric charge for charging (=an amount in Coulomb)/F]}≦12
where F is Faraday constant.

9. The nonaqueous electrolytic storage element according to claim 1, wherein the positive electrode active material is a carbonaceous material.

10. The nonaqueous electrolytic storage element according to claim 1, wherein the negative electrode active material is a carbonaceous material.

11. The nonaqueous electrolytic storage element according to claim 1,
wherein the amount of the electrolyte salt in the nonaqueous electrode at the time of completion of charging is 0.6 mol/L to 1 mol/L, and
wherein the capacity of the negative electrode per unit area is 2 times to 6 times the capacity of the positive electrode per unit area.

12. The nonaqueous electrolytic storage element according to claim 1,
wherein the amount of the electrolyte salt in the nonaqueous electrode at the time of completion of charging is 0.6 mol/L to 1 mol/L,
wherein the capacity of the negative electrode per unit area is 2 times to 6 times the capacity of the positive electrode per unit area, and
wherein the electrolyte salt is LiPF₆.

13. The nonaqueous electrolytic storage element according to claim 1,
wherein the amount of the electrolyte salt in the nonaqueous electrode at the time of completion of charging is 0.6 mol/L to 1 mol/L,
wherein the capacity of the negative electrode per unit area is 2 times to 6 times the capacity of the positive electrode per unit area, and
wherein an amount of the electrolyte salt is 0.5 mol/L to 6 mol/L.

14. The nonaqueous electrolytic storage element according to claim 1,
wherein the amount of the electrolyte salt in the nonaqueous electrode at the time of completion of charging is 0.6 mol/L to 1 mol/L,
wherein the capacity of the negative electrode per unit area is 2 times to 6 times the capacity of the positive electrode per unit area, and
wherein a maximum voltage of the nonaqueous electrolytic storage element during charging and discharging is 4.3 V to 6.0 V.

15. The nonaqueous electrolytic storage element according to claim 1,
wherein the amount of the electrolyte salt in the nonaqueous electrode at the time of completion of charging is 0.6 mol/L to 1 mol/L,
wherein the capacity of the negative electrode per unit area is 2 times to 6 times the capacity of the positive electrode per unit area, and
wherein an electric charge for charging and the amount of the electrolyte salt satisfy the following relational expression at charging voltage of 4.3 V to 6 V:
3≦{the amount of the electrolyte salt (mol)/[the electric charge for charging (=an amount in Coulomb)/F]}≦12
where F is Faraday constant.

16. The nonaqueous electrolytic storage element according to claim 1,
wherein the amount of the electrolyte salt in the nonaqueous electrode at the time of completion of charging is 0.6 mol/L to 1 mol/L,
wherein the capacity of the negative electrode per unit area is 2 times to 6 times the capacity of the positive electrode per unit area, and
wherein the positive electrode active material is a carbonaceous material.

17. The nonaqueous electrolytic storage element according to claim 1,
wherein the amount of the electrolyte salt in the nonaqueous electrode at the time of completion of charging is 0.6 mol/L to 1 mol/L,
wherein the capacity of the negative electrode per unit area is 2 times to 6 times the capacity of the positive electrode per unit area,
wherein the positive electrode active material is a carbonaceous material, and
wherein the negative electrode active material is a carbonaceous material.

18. The nonaqueous electrolytic storage element according to claim 1,
wherein the amount of the electrolyte salt in the nonaqueous electrode at the time of completion of charging is 0.6 mol/L to 1 mol/L,
wherein the capacity of the negative electrode per unit area is 2 times to 6 times the capacity of the positive electrode per unit area,
wherein the electrolyte salt is LiPF₆,
wherein the positive electrode active material is a carbonaceous material, and
wherein the negative electrode active material is a carbonaceous material.

19. The nonaqueous electrolytic storage element according to claim 1,
wherein the amount of the electrolyte salt in the nonaqueous electrode at the time of completion of charging is 0.6 mol/L to 1 mol/L,
wherein the capacity of the negative electrode per unit area is 2 times to 6 times the capacity of the positive electrode per unit area,
wherein an amount of the electrolyte salt is 0.5 mol/L to 6 mol/L,
wherein the positive electrode active material is a carbonaceous material, and
wherein the negative electrode active material is a carbonaceous material.

20. The nonaqueous electrolytic storage element according to claim 1,
wherein the amount of the electrolyte salt in the nonaqueous electrode at the time of completion of charging is 0.6 mol/L to 1 mol/L,
wherein the capacity of the negative electrode per unit area is 2 times to 6 times the capacity of the positive electrode per unit area,
wherein a maximum voltage of the nonaqueous electrolytic storage element during charging and discharging is 4.3 V to 6.0 V,
wherein the positive electrode active material is a carbonaceous material, and
wherein the negative electrode active material is a carbonaceous material.
